(19) United States
(12) Patent Application Publication
(10) Pub. No.: US 2014/0193736 A1
(43) Pub. Date: Jul. 10, 2014

(54) Fuel Cell Systems and Related Methods

(71) Applicant: LILLIPUTIAN SYSTEMS, INC., Wilmington, MA (US)

(72) Inventors: Alan P. Ludwiszewski, Andover, MA (US); Antonios E. Prentakis, Watertown, MA (US)

(73) Assignee: LILLIPUTIAN SYSTEMS, INC., Wilmington, MA (US)

(21) Appl. No.: 13/734,895

(22) Filed: Jan. 4, 2013

(51) Int. Cl. H01M 8/04

(52) U.S. Cl. CPC H01M 8/04208
USPC 429/447; 429/443

(57) ABSTRACT

A fuel cell system having a fuel cell generator and a fuel cartridge that is removably attachable to the fuel cell generator is disclosed. The fuel cartridge includes a housing having a port, a normally closed valve disposed in the housing that gates fuel emerging from the port, the valve having a poppet that modulates opening of the valve, the poppet having a control surface. The fuel cell generator has a moveable pintle coupled to the poppet, and the moveable pintle is operative over a range of motion which causes the poppet to move between a closed state and at least one open state.

### CROSS REFERENCE TO RELATED APPLICATIONS

The present application is related to U.S. patent application entitled A FUEL CELL SYSTEM HAVING AN AIR QUALITY SENSOR SUITE, Attorney Docket No. 3553/139, filed on Jan. 4, 2013, U.S. patent application entitled FUEL CELL SYSTEM HAVING A PUMP AND RELATED METHOD, Attorney Docket No. 3553/141, filed on Jan. 4, 2013, U.S. patent application entitled A FUEL CELL SYSTEM HAVING WATER VAPOR CONDENSATION PROTECTION, Attorney Docket No. 3553/142, filed on Jan. 4, 2013, U.S. patent application entitled A FUEL CELL SYSTEM HAVING A SAFETY MODE, Attorney Docket No. 3553/143, filed on Jan. 4, 2013, U.S. patent application entitled A PORTABLE FUEL CELL SYSTEM HAVING A FUEL CELL SYSTEM CONTROLLER, Attorney Docket No. 3553/144, filed on Jan. 4, 2013, U.S. patent application entitled A METHOD FOR BONDING SUBSTRATES, Attorney Docket No. 3553/145, filed on Jan. 4, 2013, and U.S. patent application entitled LOW VIBRATION LINEAR MOTOR SYSTEMS, Attorney Docket No. 3553/146, filed on Jan. 4, 2013, the disclosures of which are incorporated by reference herein in their entirety.

### TECHNICAL FIELD

The present invention relates to fuel cell systems, and more particularly to the fuel cell systems that incorporate fuel cartridges for fuel cell generators.

### BACKGROUND ART

Fuel cells that operate in conjunction with replaceable fuel canisters or cartridges filled with, for example, gaseous hydrogen, methanol, butane or diesel fuel, are a developing technology. These types of fuel cells are designed to compete with the various battery solutions that power consumer products. The competitiveness of these fuel cells with regard to batteries depends on a number of factors, such as the energy density of the fuel in the canister; the ability of the fuel cell to convert chemical energy to electrical energy with certain efficiencies; and the need to keep the fuel cell stack, along with associated fluid pumping and power control components, no larger than that of a competitive battery.

Improvements in energy density and chemical conversion efficiency have been achieved with solid-oxide-fuel cells (SOFCs), which utilize ceramic membranes instead of polymer membranes. In the SOFC systems, an oxidizing flow is passed through the cathode side of the fuel cell while a reducing flow is passed through the anode side of the fuel cell. The oxidizing flow is typically air, while the reducing flow typically comprises a mixture of a hydrogen-rich gas created by reforming a hydrocarbon fuel source and an oxygen source, such as air, water vapor or carbon dioxide. The fuel cell, typically operating at a temperature between 500° C. and 1000° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between the anode and the cathode, resulting in an electrical current flow through the circuit.

One of the advantages of the fuel cell systems over batteries is that fuel cell systems are readily refuelable, and therefore, can comprise a replaceable fuel cartridge removably attachable to a fuel cell generator. Prior art fuel cell systems that utilize replaceable fuel cartridges often have a normally closed valve in the cartridge which is configured to be opened by an uncontrolled mechanical action when the cartridge is attached to the fuel cell generator. As a result, the generator is more complicated and bulky because it must include a regulating method to control flow from the cartridge, and must include filters and protection from contaminants present in the fuel.

### SUMMARY OF THE EMBODIMENTS

In one embodiment of the invention, a fuel cartridge that is removably attachable to a fuel cell generator having a moveable pintle, that is operative over a pintle control range of motion, includes a housing having a port, and a normally closed valve disposed in the housing that gates fuel emerging from the port. The valve has a poppet that, over a poppet control range of motion, modulates opening of the valve continuously from closed to wide open, and the poppet has a control surface. The housing has a cartridge reference surface configured to mate with a corresponding generator reference surface of the fuel cell generator when the fuel cartridge is attached to the fuel cell generator, such that when the two reference surfaces are mated and the poppet is closed, there is defined a fiducial distance of the control surface of the poppet in relation to the fuel cell generator, the fiducial distance configured such that motion of the moveable pintle over its control range of motion causes the poppet to move over at least a portion of its control range of motion.

In related embodiments, the poppet may be configured so that, after the fuel cartridge is attached to the fuel cell generator and the cartridge reference surface is mated to the generator reference surface, the moveable pintle in the fuel cell generator causes motion of the poppet dynamically in a manner to regulate pressure of fuel exterior to the port. The poppet may have a poppet control range of motion, and the poppet may be configured so that, after the fuel cartridge is attached to the fuel cell generator and the cartridge reference surface is mated to the generator reference surface, the moveable pintle in the fuel cell generator causes motion of the poppet over the entire poppet control range of motion. The fuel cartridge may further include a substantially cylindrical recess exterior to the port, wherein the recess (i) is shaped, when the cartridge is attached to the fuel cell generator, to receive an annular sealing member present in the fuel cell generator, and (ii) has an interior wall dimensioned so as to fit snugly against an exterior wall of the annular sealing member, the annular sealing member having a passageway to receive fuel exiting the port.

In another embodiment of the invention, a fuel cell system includes a fuel cell generator having a moveable pintle operative over a pintle control range of motion, and a fuel cartridge removably attached to the fuel cell generator. The fuel cartridge includes a housing having a port and a normally closed valve disposed in the housing that gates fuel emerging from the port, the valve having a poppet that, over a poppet control range of motion, modulates opening of the valve continuously from closed to wide open, and wherein the poppet has a control surface. The housing has a cartridge reference surface mated with a corresponding generator reference surface of the fuel cell generator, when the fuel cartridge is thus removably attached, such that, when the poppet is closed, there is defined a fiducial distance of the control surface of the poppet in relation to the fuel cell generator, the fiducial distance configured such that motion of the moveable pintle over its control range of motion causes the poppet to move over at least a portion of its control range of motion. In addition, the fuel cell generator is configured to move the pintle when the fuel cartridge is attached to the fuel cell generator.

In related embodiments, the fuel cell generator may further include a pintle controller coupled to the moveable pintle, the pintle controller configured to move in response to an electrical signal. The poppet may have a poppet control range of motion, and the poppet may be configured so that, while the fuel cartridge is attached to the fuel cell generator, the moveable pintle in the fuel cell generator causes motion of the poppet over the entire poppet control range of motion. The fuel cartridge may further include a substantially cylindrical recess exterior to the port, and the fuel cell generator may include an annular sealing member disposed around the pintle, wherein the recess (i) is shaped, when the fuel cartridge is attached to the fuel cell generator, to receive the annular sealing member, and (ii) has an interior wall dimensioned so as to fit snugly against an exterior wall of the annular sealing member, the annular sealing member having a passageway to receive fuel exiting the port. The fuel cell generator may further include a pressure responsive component exposed to pressure downstream of the valve, the component coupled to the poppet, so that the poppet modulates opening of the valve in response to pressure downstream of the valve. The pressure response component may include a membrane, the membrane coupled to the poppet by the moveable pintle. The pressure responsive component may be configured to move the poppet towards the closed position when the pressure increases and move the poppet towards the open position when the pressure decreases. The fuel cartridge may contain a liquefied fuel, and the pressure responsive component may be configured to move the poppet to the closed position at a pressure below the vapor pressure of the fuel. The fuel cartridge may contain a liquefied fuel, and the pressure responsive component may be configured to move the poppet to the closed position at a pressure above 0.5 pounds per square inch above ambient pressure.

In further related embodiments, the fuel cell generator may further include a safety actuator having a first position and a second position, and, in the first position, the safety actuator causes the control range of motion of the pintle to overlap with the control range of motion of the poppet, and, in the second position, the safety actuator causes the control range of motion of the pintle to have no overlap with the control range of motion of the poppet. The safety actuator may include at least one of the following: a user operable switch, an electrically operated switch, a bi-stable switch, a solenoid, or combinations thereof.

In another embodiment of the invention, a fuel cell system includes a fuel cell generator and a fuel cartridge removably attached to the fuel cell generator. The fuel cartridge having a housing having a port, and a normally closed valve disposed in the housing that gates fuel emerging from the port, the valve having a poppet that modulates opening of the valve. The fuel cell generator has a moveable pintle coupled to the poppet, the pintle movable over a range of motion which causes the poppet to move between a closed state and at least one open state.

In related embodiments, the fuel cell generator may further include a pintle controller coupled to the moveable pintle, the controller configured to move in response to an electrical signal. The fuel cartridge may further include a substantially cylindrical recess exterior to the port, and the fuel cell generator may include an annular sealing member disposed around the pintle, wherein the recess (i) is shaped, when the cartridge is attached to the fuel cell generator, to receive the annular sealing member, and (ii) has an interior wall dimensioned so as to fit snugly against an exterior wall of the annular sealing member, the annular sealing member having a passageway to receive fuel exiting the port. The fuel cell generator may further include a pressure-responsive component, exposed to pressure downstream of the valve, the component coupled to the poppet, so that the poppet modulates opening of the valve in response to pressure downstream of the valve. The pressure-responsive component may include a membrane, the membrane coupled to the poppet by the moveable pintle. The pressure-responsive component may be configured to move the poppet towards the closed position when the pressure increases and move the poppet towards the open position when the pressure decreases. The fuel cartridge may contain a liquefied fuel, and the pressure responsive component may be configured to move the poppet to the closed position at a pressure below the vapor pressure of the fuel. The fuel cell body may further include a safety actuator configured to uncouple the moveable pintle from the poppet, so as to disable modulation of the poppet in response to pressure, and to cause the valve to assume a closed position. The safety actuator may include at least one of the following: a user operable switch, an electrically operated switch, a bi-stable switch, a solenoid or combinations thereof.

In another embodiment of the invention, a method for operating a fuel cell system includes providing a fuel cartridge with a poppet that is configured to modulate flow through a valve, providing a fuel cell generator with a moveable pintle that is configured to engage the poppet, attaching the fuel cartridge and the fuel cell generator, and then moving the pintle to modulate the flow through the valve.

### BRIEF DESCRIPTION OF THE DRAWINGS

The foregoing features of embodiments will be more readily understood by reference to the following detailed description, taken with reference to the accompanying drawings, in which:

FIG. 1 is a cross-sectional schematic view of a fuel cell cartridge for a fuel cell generator in accordance with one embodiment of the present invention.

FIGS. 2A, 2B and 2C are cross-sectional views of a fuel cell system showing different configurations of mating a fuel cell system with a fuel cell generator in accordance with some embodiments of the present invention.

FIGS. 3A and 3B are cross-sectional schematic views of a cartridge illustrating a pintle control range of motion in accordance with one embodiment of the present invention.

FIGS. 3C and 3D are cross-sectional schematic views of a cartridge illustrating a poppet control range of motion in accordance with one embodiment of the present invention.

FIG. 4 is a cross-sectional view of a fuel cell system illustrating a mating configuration of a cylindrical recess of a fuel cartridge with an annular sealing member of a fuel cell generator in accordance with one embodiment of the present invention.

FIG. 5 is a cross-sectional view of a fuel cell generator showing a pintle controller having a pressure-responsive component and a preloaded spring in accordance with an embodiment of the present invention.

FIG. 6A is an exemplary cross-sectional view of a fuel cell system illustrating a pintle controller having a safety actuator, a pressure-responsive component and a preloaded spring, showing a pintle and a poppet engaged and the poppet in the closed position.

FIG. 6B is an exemplary cross-sectional view of a fuel cell system illustrating a pintle controller having a safety actuator, a pressure-responsive component and a preloaded spring, showing a pintle and a poppet engaged and the poppet in the open position.

FIG. 6C is an exemplary cross-sectional view of a fuel cell system illustrating a pintle controller having a safety actuator, a pressure-responsive component and a preloaded spring, showing a pintle and a poppet disengaged and the poppet in the closed position.

### DETAILED DESCRIPTION OF SPECIFIC EMBODIMENTS

Definitions. As used in this description and the accompanying claims, the following terms shall have the meanings indicated, unless the context otherwise requires.

A “fuel cell system” includes a fuel cartridge and a fuel cell generator.

A “fuel cartridge” is a container configured to be filled with fuel and is removably attachable to an assembly that includes a fuel cell and generator, so that, when the fuel cartridge is attached to the assembly, there is formed a fuel cell system.

A “fuel cell” is any portion of the system containing at least part of the electrochemical conversion structures, including an anode, electrolyte and cathode, and also including portions of the housings, flow conduits, electronics, and other associated peripheral components coupled to the electrochemical structures.

A “fuel cell generator” includes a fuel cell and associated system components to generate electricity and deliver that electricity to an internal or external load. A fuel cell generator is configured to accept a fuel cartridge.

A “pressure responsive component” is a component that moves in response to pressure. A pressure responsive component may be a diaphragm, membrane, or a biased piston assembly; or can be an active system that employs actuators, such as electric motors, to move a poppet in response to a pressure change.

A “poppet” is a moveable member in a valve that gates flow through the valve.

A “moveable pintle” is a moveable member of the fuel cell system that causes motion of a poppet.

To “modulate” an attribute is to cause a dynamic change in value of the attribute over a range encompassing a maximum possible value, a minimum value, and at least one intermediate value.

To “move dynamically” is to cause a series of changes in position over time in response to at least one parameter, such as pressure, for example.

A “cartridge reference surface” is a mechanical feature on a fuel cartridge configured to mate with a “generator reference surface”, a mechanical feature on a fuel cell generator, such that when the two reference surfaces are mated there is defined a fiducial distance of the control surface of the poppet in relation to the fuel cell generator reference surface.

The “pintle control range” is a physical distance over which the fuel cell generator can modulate the pintle location, in relation to the fuel cell generator reference surface.

The “poppet control range” is the physical distance over which the poppet of a poppet valve in a cartridge can be modulated, in relation to the cartridge reference surface, to produce a change in flow through the poppet valve.

A pintle and a poppet are “engaged” when the pintle and the poppet are in direct contact with each other.

A pintle and a poppet are “disengaged” when the pintle and the poppet are spaced apart from each other.

A pintle and a poppet are “coupled” when the pintle control range of motion and the poppet control range of motion overlap in whole or in part.

A pintle and a poppet are “uncoupled” when the pintle control range of motion and the poppet control range of motion do not overlap. A pintle and a poppet may be uncoupled but still engaged if either the poppet is outside of its control range and therefore further motion does not modulate the flow, or if the pintle is outside of its control range and therefore unable to be modulated by the system.

Embodiments of the present invention provide a portable fuel cell system that is less expensive, more compact, and less complicated in design than the prior art systems. In addition, embodiments provide a portable fuel cell system that is more reliable in comparison with the prior art systems and that employs safety features, which enable a safe and user-friendly operation of the fuel cell system.

In order to overcome the limitations of the prior art, embodiments of the present invention seek to use an existing normally closed valve in a fuel cartridge as a modulated valve coupled with a moveable pintle on a system. This modulating configuration allows for systems which are smaller, less complicated, and have better performance. However, this requires specially constructed fuel cartridges which have suitably designed valves which are very precisely located relative to a cartridge reference surface, which can be used to provide a fiducial, mechanical reference of the fuel cartridge when it is mated to a fuel generator.

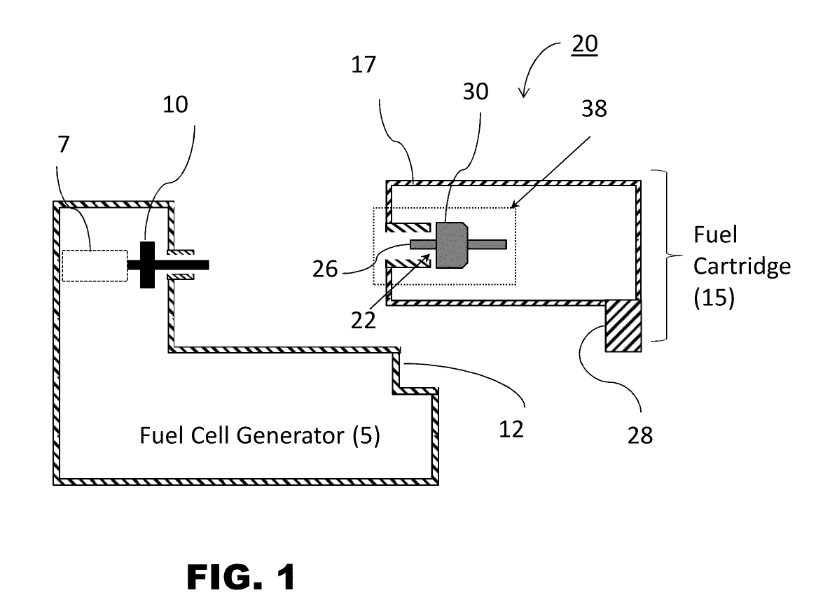

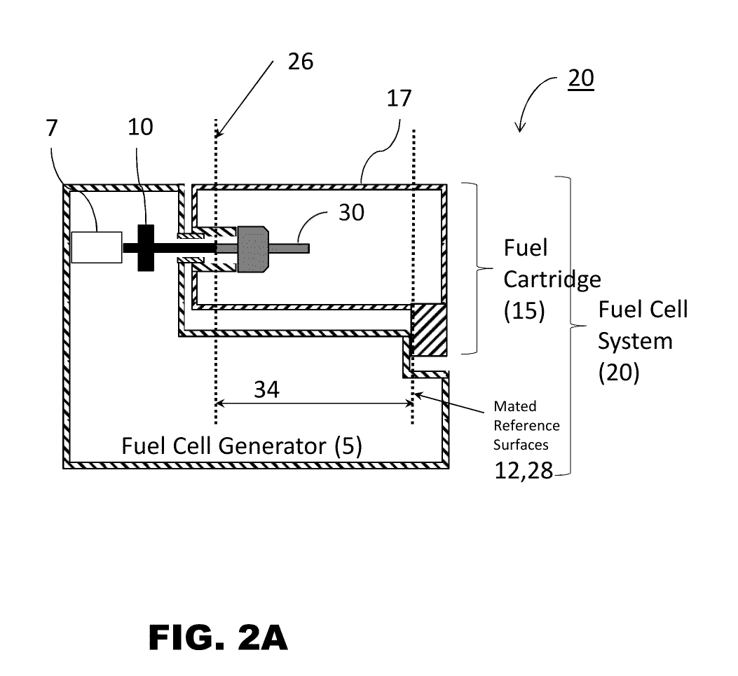

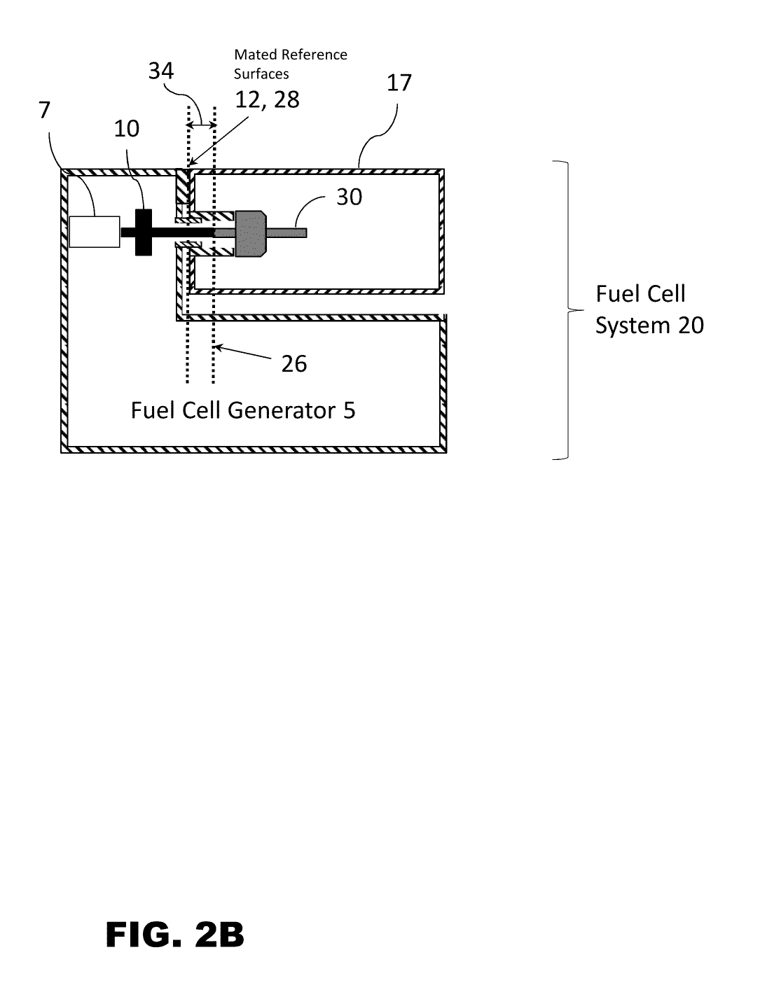

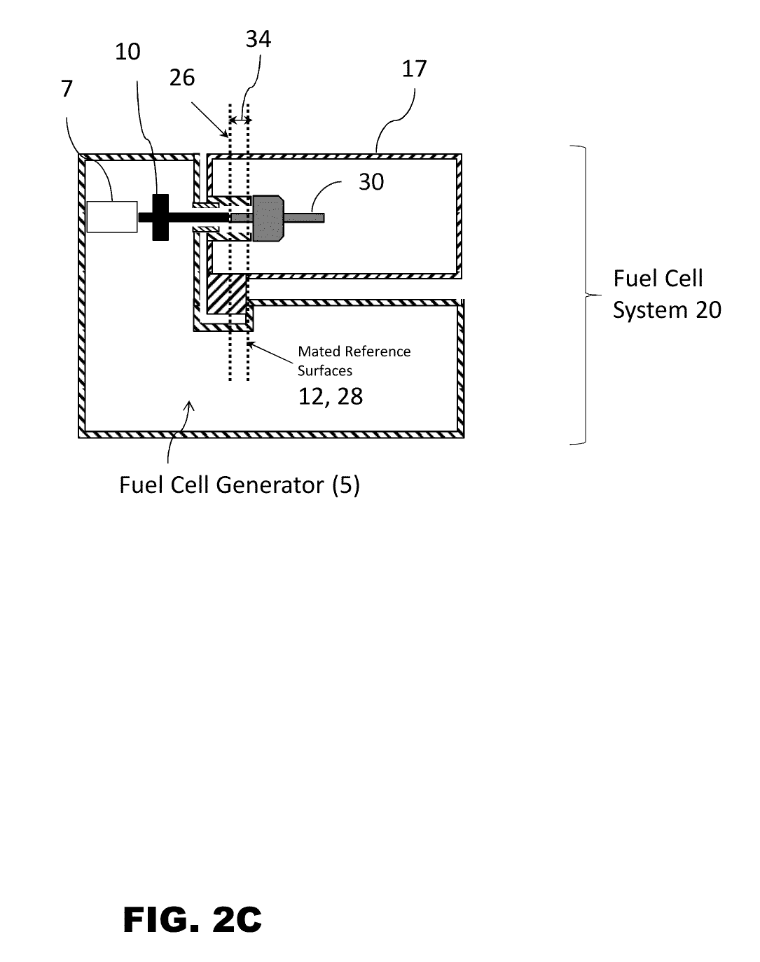

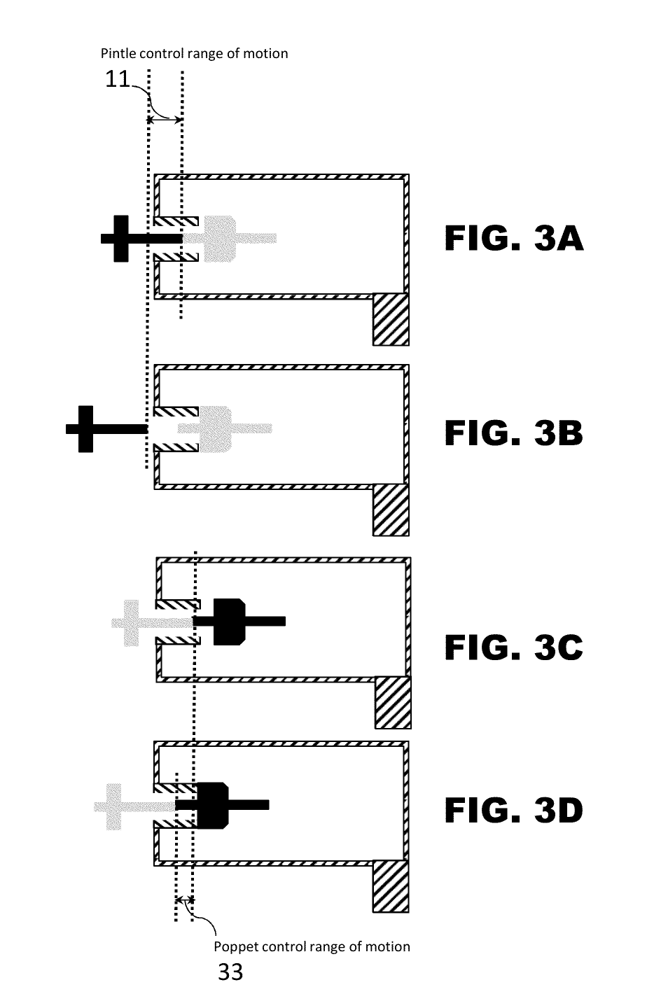

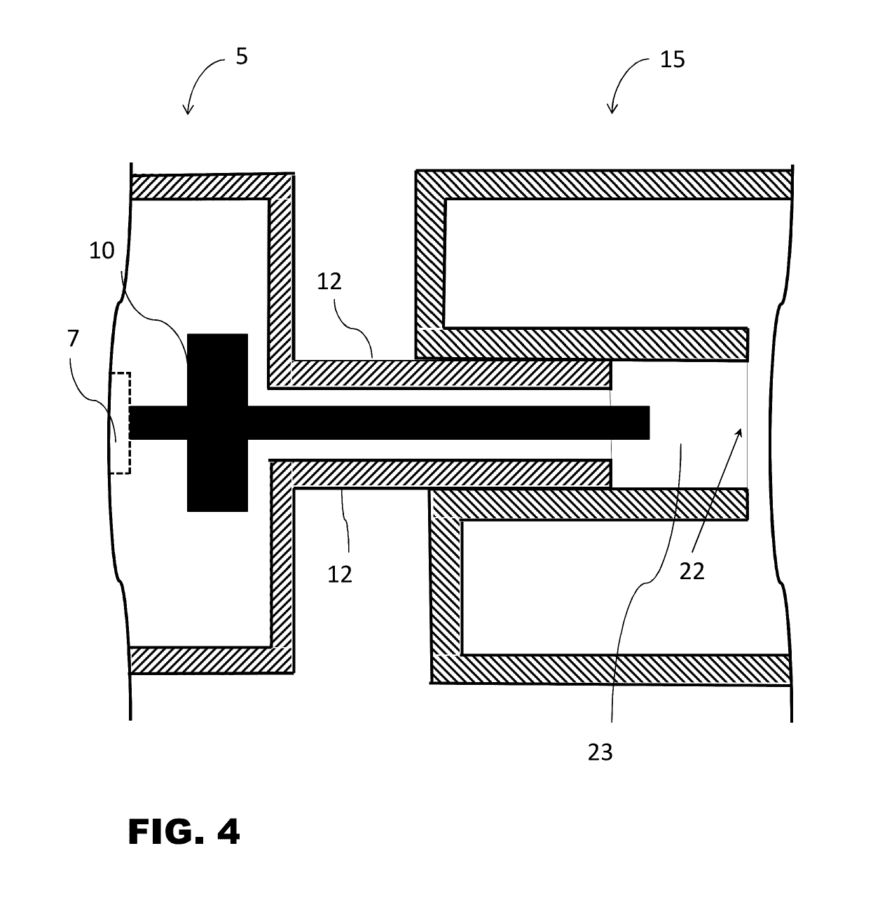

In accordance with one embodiment, as shown in FIG. 1, a fuel cell system 20 includes a fuel cell generator 5 and a fuel cartridge 15 that is removably attachable to the fuel cell generator 5. The fuel cell generator 5 has moveable pintle 10 connected to pintle controller 7, and the moveable pintle 10 is operative over pintle control range of motion 11 (shown and discussed in more detail in FIGS. 3A and 3B). The pintle controller 7 may be configured to move in response to an electrical signal. The fuel cartridge 15 includes housing 17 having port 22, normally closed valve 38 disposed in the housing 17 that gates fuel emerging from the port 22. The valve 38 includes poppet 30 that, over poppet control range of motion 33 (shown and discussed in more detail in FIGS. 3C and 3D), modulates opening of the valve 38 continuously from closed to wide open. The poppet 30 has control surface 26, and the housing 17 has cartridge reference surface 28 configured to mate to generator reference surface 12 of the fuel cell generator 5 when the fuel cartridge 15 is attached to the fuel cell generator 5. When the two reference surfaces (12, 28) are mated and the valve 38 is closed (i.e., the poppet 30 is in the closed position), as shown in FIG. 2A, there is defined fiducial distance 34 of the control surface 26 of the poppet 30 in relation to the fuel cell generator 5. The fiducial distance 34, formed from a variety of mechanical configurations, such as shown in FIGS. 2A-2C, is configured such that the motion of the moveable pintle 10 over its control range of motion 11 (shown in FIGS. 3A and 3B) causes the poppet 30 to move over at least a portion of its control range of motion 33 (shown in FIGS. 3C and 3D).

The poppet 30 can be configured such that, after the fuel cartridge 15 is attached to the fuel cell generator 5 and the cartridge reference surface 28 is mated to the generator reference surface 12, as illustrated in FIG. 2A, the moveable pintle 10 in the fuel cell generator 5 causes motion of the poppet 30 dynamically in a manner to regulate pressure of fuel exterior to the port 22, as shown in FIG. 1. The fiducial distance 34 defines how much the pintle and the poppet control range of motions (11, 33) overlap. Any variation in the alignment between the fuel cartridge 15 and the fuel cell generator 5 away from the defined fiducial distance 34 will affect the system 20 operation, in particular the pressure in the fuel cell generator 5. Therefore, it is critical to select and keep the fiducial distance 34 consistent from fuel cartridge 15 to fuel cartridge 15 and from system 20 to system 20 in order to achieve high repeatability of the system 20 operation. This becomes especially important in the context of portable fuel cell systems that require a tight pressure control.

Illustrated in FIG. 2A is one embodiment of the present invention where the cartridge reference surface 28 is a shelf extending from the cartridge housing 17, oriented approximately perpendicular to the motion of the poppet 30, and configured to be contacted in the same direction that the moveable pintle 10 protrudes from the fuel cell generator 5. The fuel cell generator reference surface 12 is configured to contact the cartridge reference surface 28.

Illustrated in FIG. 2B is another embodiment of the present invention where the cartridge reference surface 28 is formed from the exterior face of the cartridge housing 17 near the port 22 and oriented approximately perpendicular to the motion of the poppet 30. The fuel cell generator reference surface 12 is configured to contact the cartridge reference surface 28.

Illustrated in FIG. 2C is one embodiment of the present invention where the cartridge reference surface 28 is a shelf extending from the cartridge housing 17, oriented approximately perpendicular to the motion of the poppet 30, and configured to be contacted in the opposite direction that the moveable pintle 10 protrudes from the fuel cell generator 5. The fuel cell generator reference surface 12 is configured to contact the cartridge reference surface 28. The fuel cartridge 15 in this configuration may be inserted by a rotational motion to engage the reference surfaces (12, 28). Alternatively, the cartridge reference surface 28 may be configured such that it can be pushed past the generator reference surface 12 and then extended to mate the two reference surfaces (12, 28). In an additional embodiment, the generator reference surface 12 may be configured such that it is moved out of the way as the cartridge reference surface 28 is pushed past and then extended to mate the two reference surfaces (12, 28).

According to some exemplary embodiments of the present invention, a fuel cartridge 15 is configured to connect with the fuel cell generator 5 that is of a type which dynamically moves the pintle 10 in response to pressure of fuel exterior to the cartridge port 22. The poppet 30 is configured such that, when the cartridge reference surface 28 is mated to the generator reference surface 12, such as shown in FIGS. 2A-2C, the moveable pintle 10 in the fuel cell generator 5 causes motion of the poppet 30 dynamically in a manner to regulate pressure of fuel exterior to the port 22, as shown in FIG. 1.

The poppet 30 of the fuel cartridge 15 can be configured such that, after the cartridge reference surface 28 is mated to the generator reference surface 12, such as shown in FIGS. 2A-2C, the moveable pintle 10 in the fuel cell generator 5 causes motion of the poppet 30 over the entire poppet control range of motion 33, as shown in FIGS. 3C and 3D.

As illustrated in FIG. 4, according to some exemplary embodiments of the present invention, fuel cartridge 15 includes substantially cylindrical recess 23 exterior to port 22, and the fuel cell generator 5 includes an annular sealing member 12, disposed around the moveable pintle 10, and configured to seal against the surface of the cylindrical recess 23, such that the fuel exiting the port 22 is completely contained by the annular sealing member 12. The substantially cylindrical recess 23 has an interior wall dimensioned so as to fit snugly against an exterior wall of the annular sealing member 12, and the annular sealing member 12 has a passageway to receive fuel exiting the port 22. In some embodiments, the annular sealing member 12 includes a compliant material, and the cylindrical recess 23 includes a rigid sealing surface. In other embodiments, the annular sealing member 12 includes a rigid sealing surface and the cylindrical recess 23 includes a compliant material. For example, the sealing member 12 can be a gasket, such as O-ring gasket, or any other gasket suitable for creating a seal to prevent leakage of gases or liquids.

In some embodiments, the pintle controller 7 includes an electrically controlled actuator that moves the moveable pintle 10 over the pintle control range of motion 11. Suitable actuators include a rotating motor driving a screw, a piezoelectric element, a solenoid, a linear electromagnetic motor, or combinations thereof.

Embodiments of the present invention have an additional benefit for fuel cell systems which use liquefied gaseous fuels, for example butane, because the moveable poppet 30 can be configured to modulate the moveable pintle 10 such that the liquid fuel converts into gaseous form upon leaving the fuel cartridge 15. This may be accomplished by opening the valve 38 a very small amount such that the pressure downstream of the valve 38 is maintained below the vapor pressure of the fuel. This configuration has the further advantage that any contaminants dissolved into the liquid fuel are left in the fuel cartridge 15 where the liquid to gaseous conversion occurs, and not transported into the fuel cell generator 5. The pressure downstream of the valve 38 may be maintained at a fixed pressure, such as below the vapor pressure of the fuel at 0 degrees Celsius. Alternatively, the pressure downstream of the valve 38 may be maintained at a variable pressure depending on the environmental pressure or the operating temperature. For example, the pressure downstream of the valve 38 may be selected as greater than 0.5 pound per square inch higher than the atmospheric pressure.

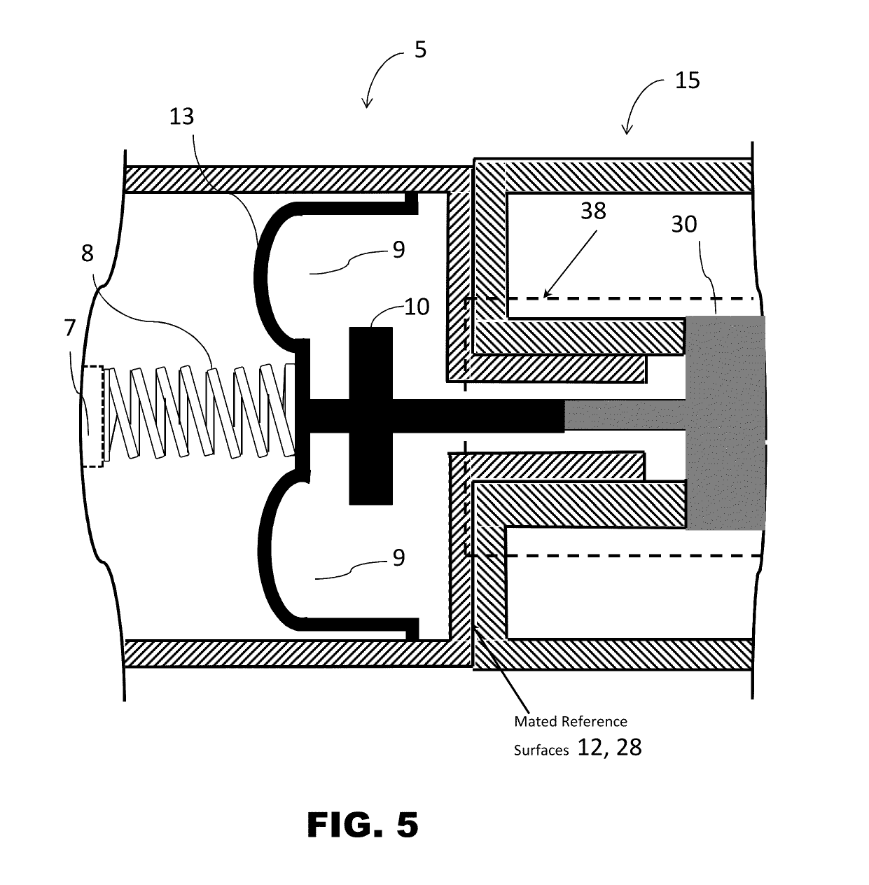

As illustrated in FIG. 5, fuel cell system 20 includes the fuel cell generator 5, which includes the pintle controller 7. The pintle controller 7 may have preloaded spring 8 coupled to pressure-responsive component 13, which is exposed to pressure downstream of the valve 38 of the fuel cartridge 15. The pressure-sensitive component 13 is coupled to the poppet 30, so that the poppet 30 modulates the opening of the valve 38 in response to pressure downstream of the valve 38. The pressure-responsive component 13 can include a membrane (not shown) coupled to the poppet 30 by the moveable pintle 10, as shown in FIG. 5. The pressure-responsive component is configured to move the poppet 30 towards the closed position of the valve 38 when the pressure in a reservoir 9 of the fuel cell generator 5 increases and to move the poppet 30 towards the open position of the valve 38 when the pressure in the reservoir 9 of the fuel cell generator 5 decreases. A pressure-responsive component 13 may be a diaphragm, membrane, or a biased piston assembly, or combinations thereof. Alternatively, or in addition, the pressure-responsive component 13 can be an active system that employs actuators such as electric motors for moving the poppet 30 in response to a pressure change.

In some embodiments, when the fuel cartridge 15 contains a liquefied fuel, such as butane, the pressure-responsive component 13 is configured to move the poppet 30 to the closed position at a pressure below the vapor pressure of the fuel.

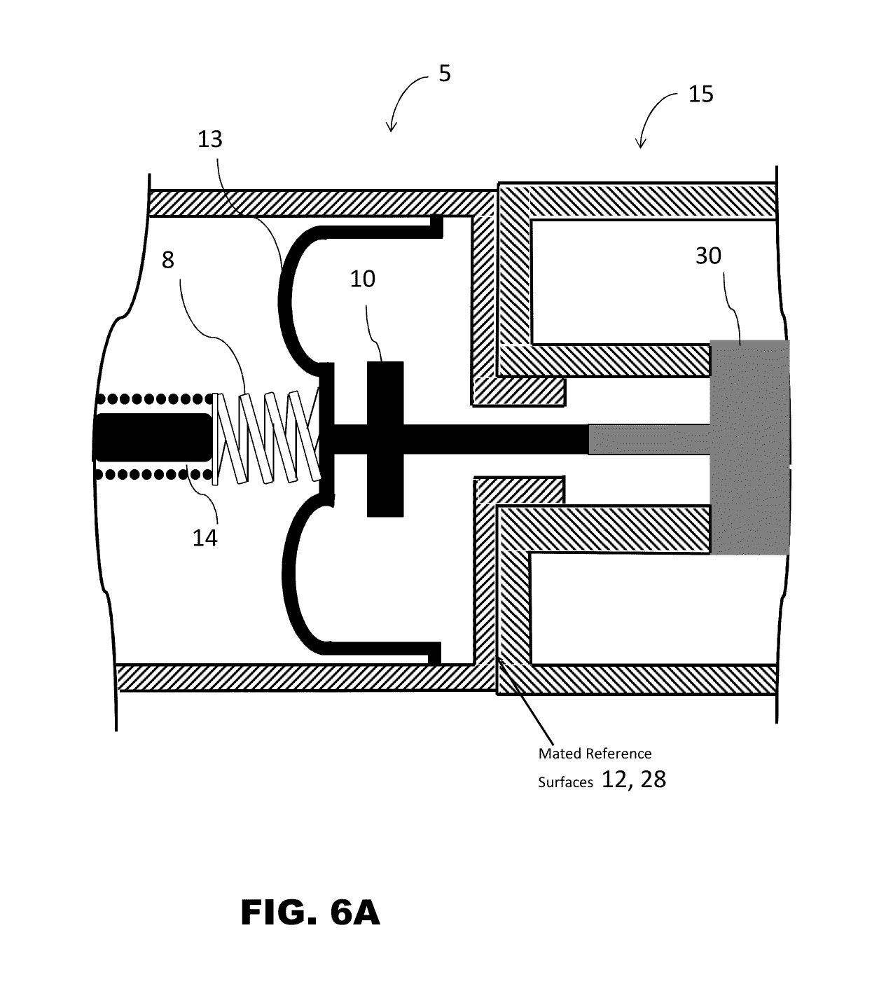

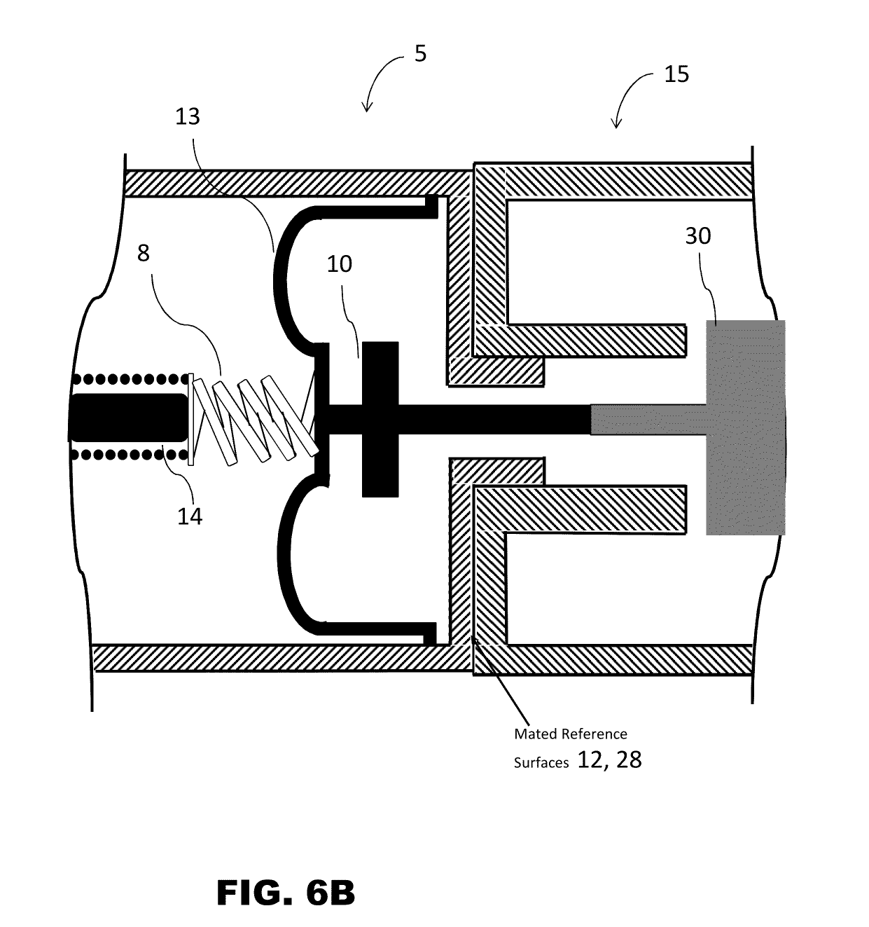

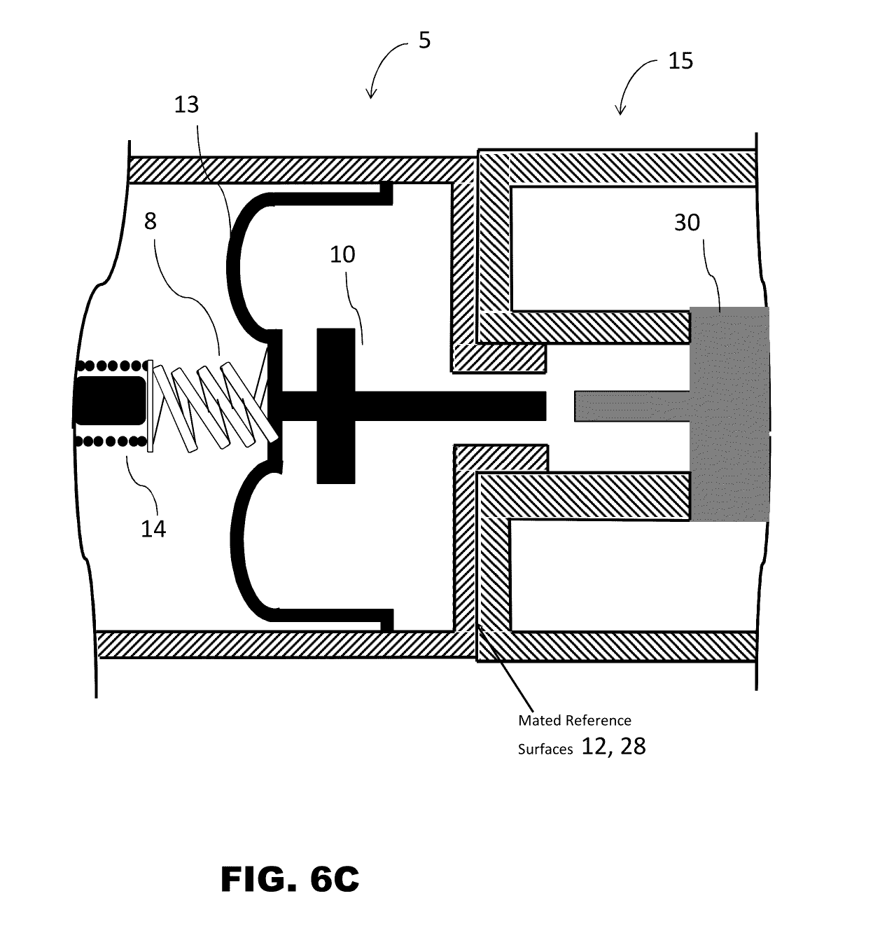

In some embodiments, the fuel system 20 includes safety actuator 14, as shown in FIGS. 6A-6C, having at least two positions. In the first position, shown in FIGS. 6A and 6B, the moveable pintle 10 is coupled with the poppet 30, and the moveable pintle 10 is able to modulate the poppet 30 over a range of motion including a closed configuration, shown in FIG. 6A, and an open position, shown in FIG. 6B. Thus, the moveable pintle 10 is movable over the range of motion, which causes the poppet 30 to move between a closed state, as shown in FIG. 6A and at least one open state, as shown in FIG. 6B. When the safety actuator 14 is in the second position, shown in FIG. 6C, the moveable pintle 10 has been moved such that the pintle control range or motion 11 no longer overlaps the poppet control range of motion 33, and the poppet 30 is fixed in a closed position. The safety actuator 14 can be a user operable switch, an electrically operated switch, a bi-stable switch, a solenoid, or any other suitable means that can be used for safety actuation purposes. The safety actuator 14 can be connected to the pressure-responsive component 13 by preloaded spring 8. For safety reasons, it is advantageous to configure the safety actuator 14 to maintain the second position in the absence of any power provided, so that the system 20 is safely off even in the event of a power failure.

A method of operating a fuel cell system 20 in accordance with the above-described embodiments of the present invention includes the steps of providing a fuel cartridge 15 with a poppet 30 that is configured to modulate flow through a valve 38, providing a fuel cell generator 5 with a moveable pintle 10 that is configured to engage the poppet 30, attaching the fuel cartridge 15 and the fuel cell generator 5, and then moving the moveable pintle 10 to modulate the flow through the valve 38.

The embodiments of the invention described above are intended to be merely exemplary; numerous variations and modifications will be apparent to those skilled in the art. All such variations and modifications are intended to be within the scope of the present invention as defined in any appended claims. For example, although some features may be included in some embodiments and drawings and not in others, these features may be combined with any of the other features in accordance with embodiments of the invention as would be readily apparent to those skilled in the art based on the teachings herein.

What is claimed is:

1. A fuel cartridge that is removably attachable to a fuel cell generator having a moveable pintle, wherein the pintle is operative over a pintle control range of motion, the fuel cartridge comprising:
a housing having a port;
a normally closed valve disposed in the housing that gates fuel emerging from the port, the valve having a poppet that, over a poppet control range of motion, modulates opening of the valve continuously from closed to wide open, and wherein the poppet has a control surface;
wherein the housing has a cartridge reference surface configured to mate with a corresponding generator reference surface of the fuel cell generator when the fuel cartridge is attached to the fuel cell generator, such that when the two reference surfaces are mated and the poppet is closed, there is defined a fiducial distance of the control surface of the poppet in relation to the fuel cell generator, the fiducial distance configured such that motion of the moveable pintle over its control range of motion causes the poppet to move over at least a portion of its control range of motion.

2. A fuel cartridge according to claim 1, wherein the poppet is configured so that, after the fuel cartridge is attached to the fuel cell generator and the cartridge reference surface is mated to the generator reference surface, the moveable pintle in the fuel cell generator causes motion of the poppet dynamically in a manner to regulate pressure of fuel exterior to the port.

3. A fuel cartridge according to claim 1, wherein the poppet has a poppet control range of motion, and wherein the poppet is configured so that, after the fuel cartridge is attached to the fuel cell generator and the cartridge reference surface is mated to the generator reference surface, the moveable pintle in the fuel cell generator causes motion of the poppet over the entire poppet control range of motion.

4. A fuel cartridge according to claim 1, further comprising a substantially cylindrical recess exterior to the port, wherein the recess (i) is shaped, when the cartridge is attached to the fuel cell generator, to receive an annular sealing member present in the fuel cell generator, and (ii) has an interior wall dimensioned so as to fit snugly against an exterior wall of the annular sealing member, the annular sealing member having a passageway to receive fuel exiting the port.

5. A fuel cell system comprising:
a fuel cell generator having a moveable pintle operative over a pintle control range of motion; and,
a fuel cartridge removably attached to the fuel cell generator and comprising:
a housing having a port;
a normally closed valve disposed in the housing that gates fuel emerging from the port, the valve having a poppet that, over a poppet control range of motion, modulates opening of the valve continuously from closed to wide open, and wherein the poppet has a control surface;
wherein the housing has a cartridge reference surface mated with a corresponding generator reference surface of the fuel cell generator, when the fuel cartridge is thus removably attached, such that, when the poppet is closed, there is defined a fiducial distance of the control surface of the poppet in relation to the fuel cell generator, the fiducial distance configured such that motion of the moveable pintle over its control range of motion causes the poppet to move over at least a portion of its control range of motion; and
wherein the fuel cell generator is configured to move the pintle when the fuel cartridge is attached to the fuel cell generator.

6. A fuel cell system according to claim 5, wherein the fuel cell generator further comprises a pintle controller coupled to the moveable pintle, the pintle controller configured to move in response to an electrical signal.

7. A fuel cell system according to claim 5, wherein the poppet has a poppet control range of motion, and wherein the poppet is configured so that, while the fuel cartridge is attached to the fuel cell generator, the moveable pintle in the fuel cell generator causes motion of the poppet over the entire poppet control range of motion.

8. A fuel cell system according to claim 5, wherein the fuel cartridge further comprises a substantially cylindrical recess exterior to the port, and wherein the fuel cell generator comprises an annular sealing member disposed around the pintle, wherein the recess (i) is shaped, when the fuel cartridge is attached to the fuel cell generator, to receive the annular sealing member, and (ii) has an interior wall dimensioned so as to fit snugly against an exterior wall of the annular sealing member, the annular sealing member having a passageway to receive fuel exiting the port.

9. A fuel cell system according to claim 5, wherein the fuel cell generator further comprises a pressure responsive component exposed to pressure downstream of the valve, the component coupled to the poppet, so that the poppet modulates opening of the valve in response to pressure downstream of the valve.

10. A fuel cell system according to claim 9, wherein the pressure response component includes a membrane, the membrane coupled to the poppet by the moveable pintle.

11. A fuel cell system according to claim 9, wherein the pressure responsive component is configured to move the poppet towards the closed position when the pressure increases and move the poppet towards the open position when the pressure decreases.

12. A fuel cell system according to claim 9, wherein the fuel cartridge contains a liquefied fuel, and the pressure responsive component is configured to move the poppet to the closed position at a pressure below the vapor pressure of the fuel.

13. A fuel cell system according to claim 9, wherein the fuel cartridge contains a liquefied fuel, and the pressure responsive component is configured to move the poppet to the closed position at a pressure above 0.5 pounds per square inch above ambient pressure.

14. A fuel cell system according to claim 9, wherein the fuel cell generator further includes a safety actuator having a first position and a second position, and, in the first position, the safety actuator causes the control range of motion of the pintle to overlap with the control range of motion of the poppet, and, in the second position, the safety actuator causes the control range of motion of the pintle to have no overlap with the control range of motion of the poppet.

15. A fuel cell system according to claim 14, wherein the safety actuator includes at least one of the following:
a user operable switch, an electrically operated switch, a bi-stable switch, and a solenoid.

16. A fuel cell system comprising:
a fuel cell generator;
a fuel cartridge removably attached to the fuel cell generator, the fuel cartridge having:
a housing having a port;
a normally closed valve disposed in the housing that gates fuel emerging from the port, the valve having a poppet that modulates opening of the valve;
wherein the fuel cell generator has a moveable pintle coupled to the poppet,
the pintle movable over a range of motion which causes the poppet to move between a closed state and at least one open state.

17. A fuel system according to claim 16, wherein the fuel cell generator further comprises a pintle controller coupled to the moveable pintle, the controller configured to move in response to an electrical signal.

18. A fuel cell system according to claim 16, wherein the fuel cartridge further comprises a substantially cylindrical recess exterior to the port, and wherein the fuel cell generator comprises an annular sealing member disposed around the pintle, wherein the recess (i) is shaped, when the cartridge is attached to the fuel cell generator, to receive the annular sealing member, and (ii) has an interior wall dimensioned so as to fit snugly against an exterior wall of the annular sealing member, the annular sealing member having a passageway to receive fuel exiting the port.

19. A fuel cell system according to claim 16, wherein the fuel cell generator further comprises a pressure-responsive component, exposed to pressure downstream of the valve, the component coupled to the poppet, so that the poppet modulates opening of the valve in response to pressure downstream of the valve.

20. A fuel cell system according to claim 19, wherein the pressure-responsive component includes a membrane, the membrane coupled to the poppet by the moveable pintle.

21. A fuel cell system according to claim 19, wherein the pressure-responsive component is configured to move the poppet towards the closed position when the pressure increases and move the poppet towards the open position when the pressure decreases.

22. A fuel cell system according to claim 19, wherein the fuel cartridge contains a liquefied fuel, and the pressure responsive component is configured to move the poppet to the closed position at a pressure below the vapor pressure of the fuel.

23. A fuel cell system according to claim 19, wherein the fuel cell body further includes a safety actuator configured to uncouple the moveable pintle from the poppet, so as to disable modulation of the poppet in response to pressure, and to cause the valve to assume a closed position.

24. A fuel cell system according to claim 23, wherein the safety actuator includes at least one of the following:
a user operable switch, an electrically operated switch, a bi-stable switch, and a solenoid.

25. A method for operating a fuel cell system, said method comprising:
providing a fuel cartridge with a poppet that is configured to modulate flow through a valve;
providing a fuel cell generator with a moveable pintle that is configured to engage the poppet;
attaching the fuel cartridge and the fuel cell generator; and then moving the pintle to modulate the flow through the valve.
